(19) United States
(12) Patent Application Publication
(10) Pub. No.: US 2010/0005263 A1
(43) Pub. Date: Jan. 7, 2010

(54) INFORMATION BACKUP METHOD, FIREWALL AND NETWORK SYSTEM

(75) Inventor: Yongqing Wu, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/469,413

(22) Filed: May 20, 2009

(30) Foreign Application Priority Data
Jul. 4, 2008 (CN) 200810133021.5
Mar. 24, 2009 (CN) PCT/CN2009/070979

(51) Int. Cl. G06F 12/16; G06F 13/00

(52) U.S. Cl. 711/162; 709/227; 709/223; 711/E12.001; 711/E12.103

(57) ABSTRACT

An information backup method, a firewall, and a network system are provided in the embodiments of the present disclosure. The method of the present disclosure implements information backup between at least two firewalls. The method includes: receiving a packet; and backing up changed session information to the another firewall if it is detected that the received packet causes the recorded session information to have changed. As such, session information recorded in the firewalls is consistent in real time.

### CROSS-REFERENCE TO RELATED APPLICATIONS

This application claims priority to Chinese Patent Application No. 200810133021.5, filed on Jul. 4, 2008, and International Patent Application No. PCT/CN2009/070979, filed on Mar. 24, 2009, both of which are hereby incorporated by reference in their entireties.

### FIELD

The present disclosure relates to the field of network communication, and more particularly to an information backup method, a firewall, and a network system.

### BACKGROUND

As monitoring and protection equipment in a network, a firewall plays an important role in network security. Current mainstream firewalls are generally state detection firewalls. Such a firewall records information of each session, and determines whether to discard a received packet according to the recorded session information dynamically. The session information includes parameters related to session establishment and state information of the existing sessions, for example, a source address, a destination address, a packet protocol type, and a session state.

In actual applications, to enhance the security and reliability, a dual-firewall hot backup networking mode is usually adopted by the firewalls. In this mode, one firewall is in a working state, and the other is in a backup state. When the firewall in the working state is faulty, the firewall in the backup state operates to replace the firewall in the working state. However, this method can ensure the integrity of the session information of each session recorded in the firewall only if paths for sending and receiving packets are identical, so that the networking configuration is complicated in practice.

A processing method supporting different paths for sending and receiving packets is proposed in the related art. A network in the related art mainly includes: a firewall 1, a firewall 2, and routers R1, R2, R3, and R4. If the conventional mode in which paths for sending and receiving packets are identical is used, the path is: R3→the firewall 1→R1→the firewall 1→R3; however, if the mode in which paths for sending and receiving packets are different is used, the path is: R3→the firewall 1→R1→R2→the firewall 2→R4. For the mode in which paths for sending and receiving packets are different in the prior art, each firewall periodically scans recorded session information, and backs up the session information to the other firewall via a heartbeat line there-between. As such, after one firewall is faulty, the other firewall may manage session services according to the session information previously backed up.

In the process of studying and practicing the related art, the inventor found that the prior technologies have the following problems: as the session information is firstly periodically scanned and then backed up in the prior art, a delay may inevitably occur, thereby causing that the session information recorded in two firewalls is not consistent in real time, so that some session services may not normally proceed. For example, if one firewall processes a session but fails to obtain latest session information of the session in time, services related to the session may not normally proceed.

### SUMMARY

Accordingly, embodiments of the present disclosure are directed to providing an information backup method, a firewall, and a network system, so as to implement consistent session information recorded in firewalls in real time.

An embodiment of the present disclosure provides a method for implementing information backup between at least two firewalls. The information backup method includes the following steps: receiving a packet; and backing up changed session information to another firewall when it is detected that the received packet causes recorded session information to have changed.

Another embodiment of the present disclosure further provides a firewall. The firewall includes a receiving unit configured to receive a packet and a processing unit configured to back up changed session information to another firewall when detecting that the received packet causes recorded session information to have changed.

Another embodiment of the present disclosure further provides a network system. The network system includes a first firewall configured to receive a packet, detect whether the received packet causes recorded session information to have changed, and send out the changed session information if yes; and a second firewall configured to receive and back up the changed session information sent by the first firewall.

In the technical solutions provided by the embodiments of the present disclosure, once it is detected that the recorded session information is changed by a received packet, the changed session information is backed up to the another firewall, so that through such a real time backup mechanism, the session information recorded in the firewalls is ensured to be consistent in real time.

### BRIEF DESCRIPTION OF THE DRAWINGS

In order to clearly describe the technical solutions of the embodiments of the present disclosure, accompanying drawings used to describe the embodiments of the present disclosure may be described simply as follows. For the common skilled person in the prior art, other drawings may be obtained according to the following drawings without paying any creative effort.

FIG. 1 is a flow chart of an information backup method according to a first embodiment of the present disclosure;

FIG. 2 is a flow chart of an information backup method according to a second embodiment of the present disclosure;

FIG. 3 is a flow chart of an information backup method according to a third embodiment of the present disclosure;

FIG. 4 is a schematic structural view of a firewall according to an embodiment of the present disclosure; and

FIG. 5 is a schematic structural view of a network system according to an embodiment of the present disclosure.

### DETAILED DESCRIPTION

The technical solutions of the embodiments of the present disclosure may be clearly and fully described below with reference to the accompanying drawings. It is obvious that the embodiments to be described are only a part rather than all of the embodiments of the present disclosure. All other embodiments obtained by the common skilled person in the art based on the embodiments described in the present disclosure without paying any creative effort should fall within the protective scope of the present disclosure.

The embodiments of the present disclosure provide an information backup method, so as to implement session information recorded in firewalls consistent in real time, so that session services normally proceed.

In the embodiments of the present disclosure, for the backup of session information, firewalls are not categorized according to their active or standby states. That is, when a first firewall is an active firewall and a second firewall is a standby firewall, the session information may be backed up either from the active firewall to the standby firewall or from the standby firewall to the active firewall.

The embodiments of the present disclosure are described in detail in the following with reference to the accompanying drawings.

### The First Embodiment

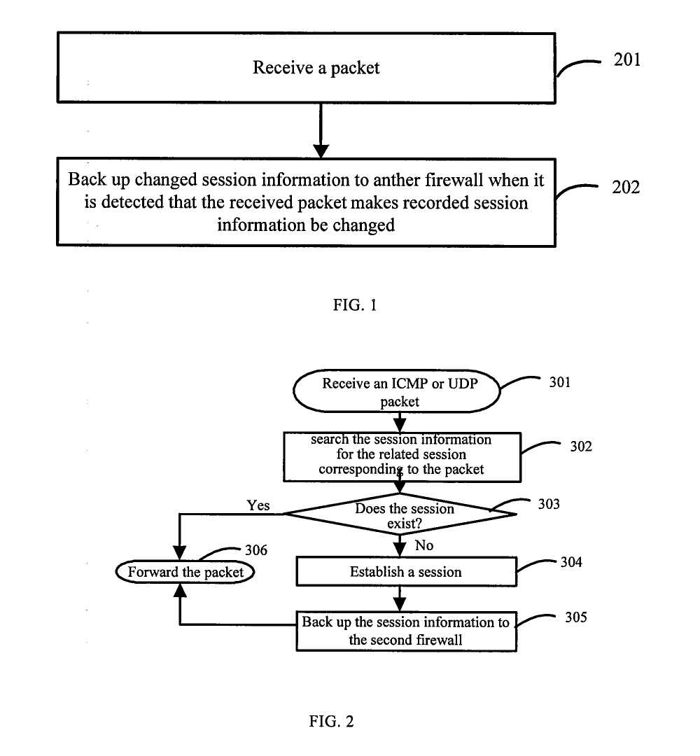

FIG. 1 is a flow chart of an information backup method according to the first embodiment of the present disclosure, in which a first firewall and a second firewall are taken for example. Referring to FIG. 1, the method includes the following steps.

In block 201, the first firewall receives a packet.

The first firewall may receive packets of various protocol types. The packet may be an Internet Control Message Protocol (ICMP) packet, a User Datagram Protocol (UDP) packet, or a Transmission Control Protocol (TCP) packet.

In block 202, when the first firewall detects that the received packet causes recorded session information to have changed, the first firewall backs up the changed session information to the second firewall.

The first firewall immediately backs up the changed session information to the second firewall upon detecting that the received packet causes the recorded session information to have changed.

The recorded session information being changed by the received packet is detected, which may indicate that a new session needs to be established according to the received packet, and new session information is added, thereby the recorded session information is changed, or may indicate that the original session state is changed and the session information needs to be updated, thereby the recorded session information is changed.

In the first embodiment, the changed session information is backed up to the second firewall immediately when it is detected that the received packet causes the recorded session information to have changed, so that the session information in the second firewall and the first firewall is ensured to be consistent in real time.

In specific implementations in network systems, the information backup method of the present disclosure is implemented in different manners depending on different packet protocols. The embodiments of the present disclosure are further described in detail below according to different packet protocols.

### The Second Embodiment

FIG. 2 is a flow chart of an information backup method according to the second embodiment of the present disclosure. The second embodiment mainly describes a processing flow in which a firewall receives an ICMP or UDP packet, and is described by taking a first firewall and a second firewall as an example. A UDP/ICMP-based session is generally a connectionless session, and there is no changed state of the session, so the processing flow is relatively simple. Referring to FIG. 2, the method includes the following steps.

In block 301, the first firewall receives an ICMP or UDP packet.

In block 302, the first firewall searches the session information recorded therein for the related session corresponding to the packet.

The first firewall records session information related to sessions, and the session information may be stored in a special memory. When receiving the packet, the first firewall searches for a related session corresponding to the packet in the session information recorded therein according to related information carried in the packet.

In block 303, it is determined whether the session exists according to a searching result. If the session exists, block 306 is performed; if the session does not exist, block 304 is performed.

The first firewall may know whether a session has been established previously by searching the session information recorded therein for the related session corresponding to the packet. If a session has been established, information related to the session may be stored, and thus the first firewall determines that the session exists, and step 306 is performed. Otherwise, the first firewall determines that the session does not exist, and step 304 is performed.

In block 304, the first firewall establishes an ICMP or UDP session, and step 305 is performed.

After determining that the session corresponding to the received packet does not exist according to the searching result, when the first firewall determines that the packet is allowed to pass there-through according to a preset access rule, the first firewall establishes an ICMP or UDP session according to the received packet and adds session information of the new session. At this time, the session information recorded in the first firewall has been changed. If the first firewall determines that the packet is not allowed to pass there-through, the first firewall discards the packet, the process ends, and no session is established.

In block 305, the session information of the ICMP or UDP session is backed up to the second firewall, and step 306 is performed.

The first firewall immediately backs up the session information of the ICMP or UDP session to the second firewall via a heartbeat line between the firewalls, so as to ensure that the session information recorded in the second firewall and the first firewall is consistent in real time.

In block 306, the ICMP or UDP packet is forwarded.

In the above process, the description that the session information is backed up first and then the packet is forwarded is given as an example, or the backup of the session information and the forwarding of the packet may also concurrently occur, or the packet is forwarded first and then the session information is backed up.

In the second embodiment, after the ICMP or UDP packet is received, the changed session information is backed up to the second firewall immediately when it is detected that the recorded session information is changed by the newly established ICMP or UDP session, so that the session information recorded in the second firewall and the first firewall is ensured to be consistent in real-time.

### The Third Embodiment

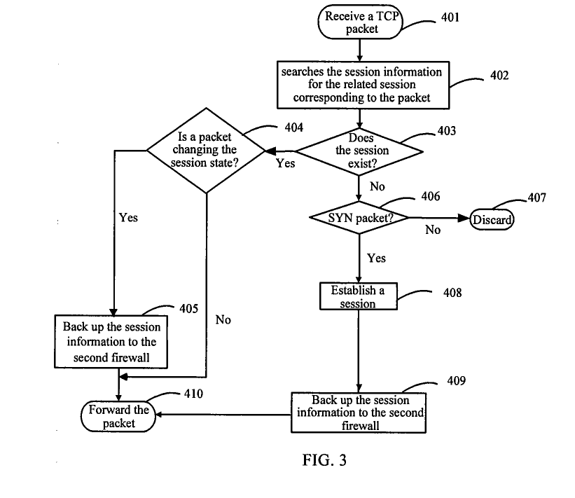

FIG. 3 is a flow chart of an information backup method according to the third embodiment of the present disclosure. The third embodiment is mainly related to a processing flow in which a firewall receives a TCP packet, and is described by taking a first firewall and a second firewall as an example. As a TCP-based session has different states, the processing flow is relatively complex, but the principle also mainly lies in that when a firewall detects that recorded session information is changed, the changed session information is backed up to the other firewall. Here, the recorded session information being changed is detected, which may include that session information is added when a new session is established, that the session information is updated, for example, the session information is modified or deleted, due to a change in the session state of an established session, or the like.

Referring to FIG. 3, the method includes the following steps.

In block 401, the first firewall receives a TCP packet.

In block 402, the first firewall searches the session information recorded therein for the related session corresponding to the packet.

The first firewall records session information related to sessions, and the session information may be stored in a special memory. When receiving the packet, the first firewall searches the session information recorded therein for the related session corresponding to the packet.

In block 403, it is determined whether the session exists according to a searching result. If the session exists, block 404 is performed; if the session does not exist, block 406 is performed.

The first firewall may know whether a session has been established previously by searching the session information recorded therein for the related session corresponding to the packet. If a session has been established, information related to the session may be stored, and thus the first firewall determines that the session exists, and block 404 is performed. Otherwise, the first firewall determines that the session does not exist, and block 406 is performed.

In block 404, it is determined whether the received packet is a packet changing a session state of the existing session. If yes, block 405 is performed; otherwise, block 410 is performed.

In the TCP packet, the packet changing the session state may be an SYN+ACK packet, an ACK packet, an RST packet, or an FIN packet. The SYN+ACK packet is an acknowledgment packet of a connection establishment request, which is configured to acknowledge the connection establishment request. The ACK packet is an acknowledgment packet, and in a TCP connection, all packets except the first packet (i.e. an SYN packet) are configured with this field as a response to a preceding packet. The RST packet is a reset packet. The FIN packet is a finish packet. Only some examples are described, and other packets that may change the session state are not listed herein.

In block 405, the updated session information is backed up to the second firewall, and step 410 is performed.

After determining that the received packet is a packet changing the session state of the existing session, the first firewall updates session information of the corresponding session. At this time, the recorded session information is changed. The first firewall immediately backs up the updated session information of the TCP to the second firewall via a heartbeat line between the firewalls, so as to ensure that the session information recorded in the second firewall and the first firewall is consistent in real time.

In block 406, it is determined whether the packet is an SYN packet. If yes, block 408 is performed; otherwise, block 407 is performed.

In block 407, the packet is discarded, and the process ends.

In block 408, the first firewall establishes a TCP session, and block 409 is performed.

In the TCP protocol, a TCP session is established after an SYN packet is received. After it is determined that the received packet is an SYN packet, a TCP session is established according to the packet, and session information of the session is added. At this time, the session information recorded in the first firewall is changed.

In block 409, the newly recorded session information is backed up to the second firewall, and step 410 is performed.

The first firewall immediately backs up the session information recorded for the newly established session to the second firewall via the heartbeat line between the firewalls, so as to ensure that the session information recorded in the second firewall and the first firewall is consistent in real time.

In block 410, the packet is forwarded.

In the above process, the description that the session information is backed up first and then the packet is forwarded is given as an example, or the backup of the session information and the forwarding of the packet may also concurrently occur, or the packet is forwarded first and then the session information is backed up.

The above embodiments are described by taking that two firewalls backup the session information between each other as an example, and the principle for an N+1 (N>2) backup networking mode in a network system is similar.

An information backup method is described in detail through the above embodiments. Accordingly, embodiments of the present disclosure provide a firewall and a network system.

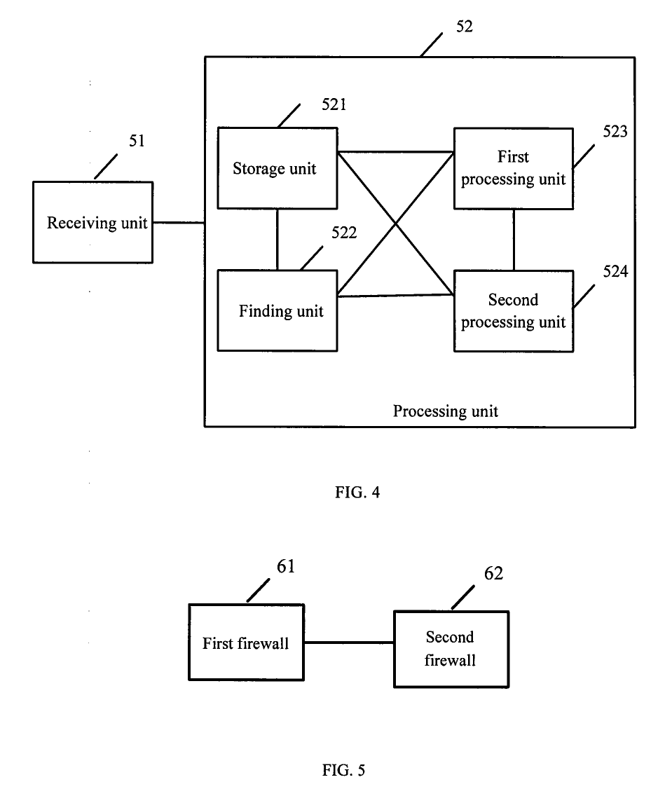

FIG. 4 is a schematic structural view of a firewall according to an embodiment of the present disclosure.

As shown in FIG. 4, the firewall includes a receiving unit 51 and a processing unit 52.

The receiving unit 51 is configured to receive a packet.

The processing unit 52 is configured to back up changed session information to another firewall when detecting that the received packet causes recorded session information to have changed.

The processing unit 52 further includes a storage unit 521, a finding unit 522, and a first processing unit 523.

The storage unit 521 is configured to record session information.

The finding unit 522 is configured to search the session information recorded in the storage unit 521 for the related session corresponding to the packet.

The first processing unit 523 is configured to establish a session according to the packet when the finding unit 522 fails to search out the related session corresponding to the packet, add session information of the session to the storage unit 521, and back up the added session information to the another firewall. At this time, the packet processed by the first processing unit 523 may be an ICMP packet, a UDP packet, or an SYN packet in a TCP packet.

The processing unit 52 further includes a second processing unit 524.

The second processing unit 524 is configured to update session information corresponding to the session in the storage unit 521 according to the packet when the finding unit 522 searches out the related session corresponding to the packet and it is further determined that the packet is a packet changing a session state, and configured to back up the updated session information to the another firewall. Here, the updating the session information corresponding to the session includes modifying or deleting the session information corresponding to the session. The packet changing the session state includes an SYN+ACK packet, an ACK packet, an RST packet, or an FIN packet in a TCP packet.

FIG. 5 is a schematic structural view of a network system according to an embodiment of the present disclosure.

As shown in FIG. 5, the network system includes a first firewall 61 and a second firewall 62.

The first firewall 61 is configured to receive a packet, detect whether the received packet causes recorded session information to have changed, and send out the changed session information if yes.

The second firewall 62 is configured to receive and back up the changed session information sent by the first firewall 61.

The first firewall 61 further includes a receiving unit and a processing unit.

The receiving unit is configured to receive a packet.

The processing unit is configured to search the session information recorded therein for the related session corresponding to the packet, establish a session according to the packet when the session corresponding to the packet is not searched out, add session information of the session, and back up the added session information to the another firewall. The processing unit updates session information corresponding to the session according to the packet when searching out the session corresponding to the packet and further determining that the packet is a packet changing a session state, and the processing unit backs up the updated session information to the another firewall.

A more detailed structure of the first firewall 61 is as shown in FIG. 4, and the details may not be described here again. The first firewall 61 and the second firewall 62 are relative, and the second firewall 62 may also have the structure shown in FIG. 4.

To sum up, in the technical solutions of the present disclosure, once it is detected that recorded session information is changed by a received packet, the changed session information is backed up to another firewall, so that through such a real time backup mechanism, the session information recorded in the firewalls is ensured to be consistent in real time.

Furthermore, the technical solutions of the present disclosure provide different processing flows for the received packets of different protocol types, and are thus more flexible.

Persons of ordinary skill in the art should understand that all or a part of processes in the method according to the embodiments may be implemented through a computer program instructing relevant hardware. The program may be stored in a computer readable storage media. When the program is executed, the processes of the method according to the embodiments of the present disclosure are performed. The storage media may be a magnetic disk, an optical disk, a read-only memory (ROM), or a random access memory (RAM).

Finally, it should be noted that the above embodiments are merely provided for describing the technical solutions of the present disclosure, but are not intended to limit the present disclosure. It should be understood by persons of ordinary skill in the art that although the present disclosure is described in detail with reference to the foregoing embodiments, modifications can be made to the technical solution described in the foregoing embodiments, or equivalent replacements can be made to some technical features in the technical solutions, and such modifications or replacements do not cause the essence of corresponding technical solutions to depart from the spirit and scope of the embodiments of the present disclosure.

What is claimed is:

1. A method for implementing information backup between at least two firewalls, comprising:
receiving a packet; and
backing up changed session information to another firewall if it is detected that the received packet causes recorded session information to have changed.

2. The method according to claim 1, wherein the packet is an Internet control message protocol packet, a user datagram protocol packet, or a transmission control protocol packet.

3. The method according to claim 1, wherein the backing up the changed session information to the another firewall when it is detected that the received packet causes the recorded session information to have changed comprises:
searching the session information recorded for the related session corresponding to the packet, establishing a session according to the packet if the session corresponding to the packet is not searched out, adding session information of the session and backing up the added session information to the another firewall.

4. The method according to claim 3, further comprising:
updating session information corresponding to the session according to the packet if the session corresponding to the packet is searched out and it is further determined that the packet is a packet changing a session state, and backing up the updated session information to the another firewall.

5. The method according to claim 4, wherein the updating the session information corresponding to the session comprises: modifying or deleting the session information corresponding to the session.

6. The method according to claim 4, wherein the packet changing the session state comprises: an acknowledgment of a connection establishment request packet, an acknowledgment packet, a reset packet, or a finish packet in a TCP packet.

7. A firewall, comprising:
a receiving unit, configured to receive a packet; and
a processing unit, configured to back up changed session information to another firewall when detecting that the received packet causes recorded session information to have changed.

8. The firewall according to claim 7, wherein the processing unit comprises:
a storage unit, configured to record session information;
a finding unit, configured to search the session information recorded in the storage unit for the related session corresponding to the packet; and
a first processing unit, configured to establish a session according to the packet when the finding unit fails to search out the session corresponding to the packet, add session information of the session to the storage unit, and back up the added session information to the another firewall.

9. The firewall according to claim 8, wherein the processing unit further comprises:
a second processing unit, configured to update session information corresponding to the session in the storage unit according to the packet if the finding unit searches out the session corresponding to the packet and it is further determined that the packet is a packet changing a session state, and back up the updated session information to the another firewall.

10. A network system, comprising:
a first firewall, configured to receive a packet, detect whether the received packet causes recorded session information to have changed, and send out the changed session information if the received packet causes recorded session information to have changed; and
a second firewall, configured to receive and back up the changed session information sent by the first firewall.

11. The network system according to claim 10, wherein the first firewall comprises:
a receiving unit, configured to receive the packet; and
a processing unit, configured to search the session information recorded for the related session corresponding to the packet, establish a session according to the packet if the session corresponding to the packet is not searched out, add session information of the session, and back up the added session information to the another firewall.

12. The network system according to claim 11, wherein the processing unit updates session information corresponding to the session according to the packet if searching out the session corresponding to the packet and further determining that the packet is a packet changing a session state, and the processing unit backs up the updated session information to the another firewall.

13. A machine-readable medium that provides instructions, which when executed by a set of one or more processors, causes said set of processors to perform operations comprising:
receiving a packet; and
backing up changed session information to another firewall if it is detected that the received packet causes recorded session information to have changed.

14. The machine-readable medium according to claim 13, wherein the packet is an Internet control message protocol packet, a user datagram protocol packet, or a transmission control protocol packet.

15. The machine-readable medium according to claim 13, wherein the backing up the changed session information to the another firewall when it is detected that the received packet causes the recorded session information to have changed comprises:
searching the session information recorded for the related session corresponding to the packet, establishing a session according to the packet if the session corresponding to the packet is not searched out, adding session information of the session and backing up the added session information to the another firewall.

16. The machine-readable medium according to claim 15, when executed by a set of one or more processors, causes said set of processors to perform operations further comprising:
updating session information corresponding to the session according to the packet if the session corresponding to the packet is searched out and it is further determined that the packet is a packet changing a session state, and backing up the updated session information to the another firewall.
